(19) United States
(12) Patent Application Publication
(10) Pub. No.: US 2004/0235338 A1
(43) Pub. Date: Nov. 25, 2004

(54) Plug connector with safety switch

(76) Inventor: Han-Ming Lee, Hsin Chu City (TW)

Correspondence Address: HAN-MING LEE, P.O. BOX 7-288, HSIN CHU CITY, TAIPEI, TW

(21) Appl. No.: 10/441,497

(22) Filed: May 20, 2003

(51) Int. Cl. H01R 3/00

(52) U.S. Cl. 439/490

(57) ABSTRACT

The present invention is related to a plug connector with safety switch, which means the connector mainly having a safety switch pivotally coupled inside a base body for the application of the connector and comprising an accommodating compartment on one side of the connector. The platform of said compartment having a terminal strip with corners and a convex circular cross it, and a switch connecting member having a central hole for implanting a bouncing element. A valve axle propping at one end of a vector board such that the terminal strips of the platform are protruded from the surface for crossing and supporting the vector board into a bi-directional swinging condition. The arc of the valve axle normally attaches onto a curved track of the board for attaining the pendulum switching effect in anticlockwise direction. The bouncing element in the hole of the connecting member contracts and expands back and forth as the surface of the curved track reciprocates so that the valve axle is driven by the piston movement to cope with the swinging. A LED is connected to check the power supply and a cover is installed to prevent water from permeating inside that may cause short circuit. Such arrangement can assure that the plug connector with safety switch will not produce sparks or static charges that may endanger life and property.

### BACKGROUND OF THE INVENTION

In the electrical era, where the applications of electric appliances are prevailing, plug has significant mission to provide power for civil and industrial usages, as well as for daily life of individual people. A plug will need to work together with a connector. That is, it takes two separated units to bring the power supply function into effect, however, they also cause some safety problems. Traditionally, there are two types of plug connectors, one is that the inserted strip is locked and bolted by the upper casing and the lower casing, and the other is the combination of inserted strip electric wire and plug. The former one, lock and blot type, when it is in use, the strip will be loosened easily which will cause poor contact and cause accidents. Latter one, although it is formulated via molding and the connection is relatively stable, however, the plug itself does not have the ON/OFF switch and users have to plug or unplug the plug directly into/from the socket, which will cause electric sparks. Also, because the terminal strip of the plug has been exposed under the moisture environment, it could produce static charge easily. At last and not least, if the electric wire is not long enough then it is necessary to have an extension cord for the connection, it could cause the electric shock during the frequent plug and unplug actions. Indeed, to improve the current plug connectors become necessary for the safety sake.

### SUMMARY OF THE INVENTION

The primary objective of the present invention is to provide the plug connector with safety switch, consisting of a terminal strip, resistor, LED, vector board, switch base, cover, and socket as well as an additional safety switch to protect users from sparks, static charges, or other dangers.

The secondary objective of the present invention is to provide the plug connector with safety switch, mainly comprising an accommodating compartment on one side of the connector, and the platform of said compartment having an terminal strip with corners and a convex circular cross terminal strip, and a switch connecting member having a central hole for implanting a bouncing element, and a valve axle propping at one end of a vector board.

Another objective of the present invention is to provide the plug connector with safety switch which the terminal strip of the platform are protruded from the surface for crossing and supporting the vector board into a bi-directional swinging condition, and the arc of the valve axle normally attaches onto a curved track of the board for attaining the pendulum switching effect in anticlockwise direction.

A further objective of the present invention is to provide the plug connector with safety switch, wherein the bouncing element in the hole of the connecting member contracts and expands back and forth as the surface of the curved track reciprocates so that the valve axle is driven by the piston movement to cope with the swinging.

Another further objective of the present invention is to provide the plug connector with safety switch, wherein a LED is connected to check the power supply and a cover is installed to prevent water from permeating inside that may cause short circuit. Such arrangement can assure that the plug connector with safety switch will not produce sparks or static charges that may endanger users' life and property.

### BRIEF DESCRIPTION OF THE DRAWINGS

FIG. 1 is a diagram illustrates the structure of the plug connector of the invention with safety switch;

FIG. 2 is a diagram illustrates the assembly components of the invention;

FIG. 3 is a cross-sectional diagram of the plug connector of the invention with safety switch;

FIG. 4 is a cross-sectional diagram illustrating the switching function of the invention; and

FIG. 5 is a diagram illustrates the socket valve axle functioning according to the piston movement of the arc board track of a preferred embodiment of the present invention.

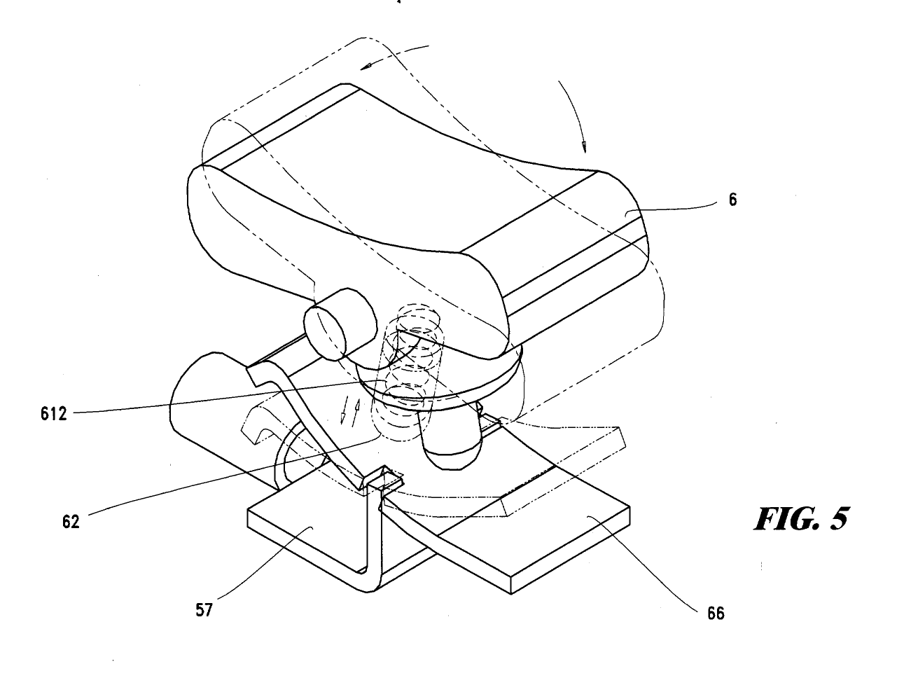

### DETAILED DESCRIPTION OF THE PREFERRED EMBODIMENT

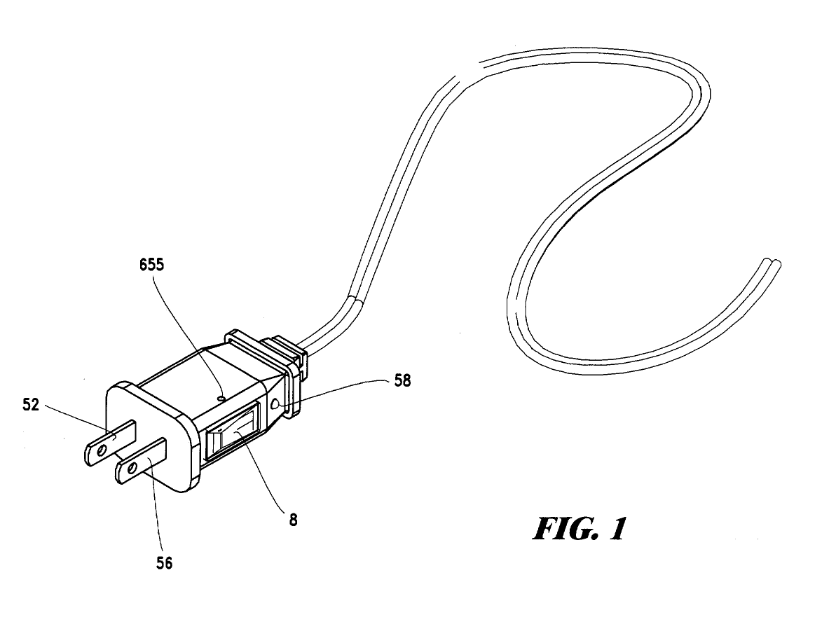

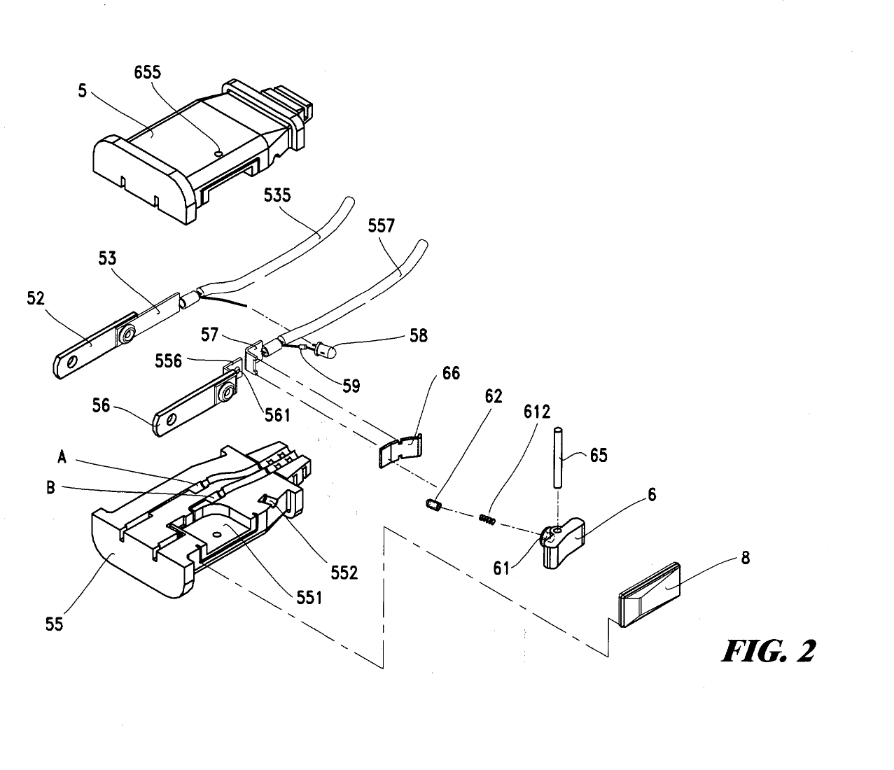

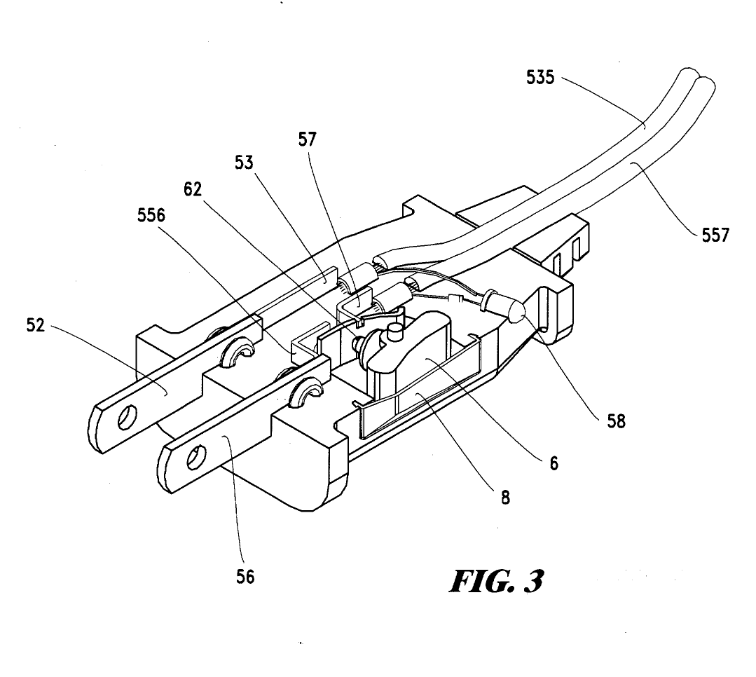

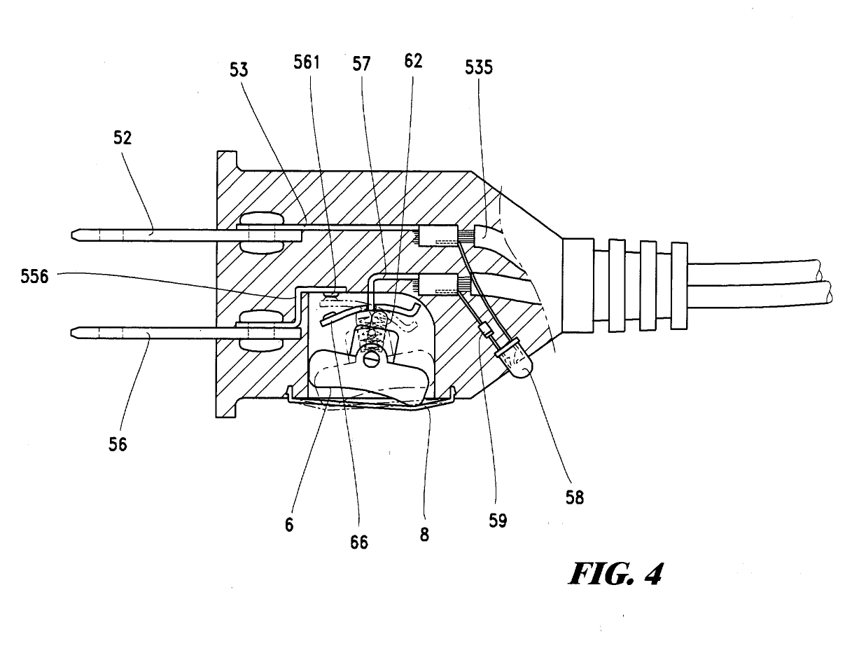

Please refer to FIGS. 1 to 4 for the present invention is related to a plug connector with safe switch and is comprised of a terminal strip, resistor, LED, vector board, switch base, cover, socket and so on. As the socket is cast, it forms an upper connecting body 5 and a lower connecting body 55, such that the two connecting bodies 5, 55 define an accommodating groove 551 on one side, and two end strips of an electric pole 52, 53 and electric wire 535, and an insert plate of different electric poles 56, 556 pivotally coupled to the S, and connected to groove tracks A and B of the electric wire 57, 577 of the opposite angular end strips. An electric wire from each of the two electrically connected ends is connected respectively to the LED 58 and resistor 59 under the accommodating, groove chamber 552 for visually inspect the power supply, and the platform of the empty groove chamber 551 has-protruded angular terminal strip 57 and a convex circular section 561 with contact with another terminal strip using two wing members of the protruded terminal strip to align and engage the middle section of the curved section of the vector board 7 with the holes on both side for supporting and providing the swinging movement. A switch 6 has a central hole 61 on the connecting member, and a bouncing element 612 is disposed inside the hole with its rear end coupling to a contractible valve axle 62 to enter the accommodating groove chamber. A latch 65 passes through the surface hole 655 and the switch hole for the positioning, such that the front half curve arc surface of the valve axle 62 normally attaches onto the curved track of the vector board 66 for facilitating the bouncing member in the switch connecting member to move back and forth as the curved track surface contracts and expands, so that the valve axle is in a piston movement. The axle arc corner swings in clockwise and anticlockwise according to the bi-directional control of the track surface such that that the power supply of the angular terminal strips connects/disconnects, with the convex circular section of the plate S on the opposite end. An electric wire is used to connect the LED 58 blinking light for the visual inspection of the power supply. A cover 8 is mounted around the frame of the switch to prevent water from permeating into the circuit that may cause short circuit. Such arrangement f this plug connector with safety switch will protect the users from producing sparks, electric charges, or other dangers.

The novel connecting structure of the present invention is installed a safety switch in a chamber on the side of the socket as an integral part for the application. Besides abandoning the structure of the past connector having two different connector and socket that occupies mores spaces and makes the use inconvenient, the present invention can also prevent sparks, static charges, or other dangers to users and provide additional safety device for the electric appliance since the traditional connectors do not have safety switch.

While the invention has been described by means of specific embodiments, numerous modifications and variations could be made thereto by those skilled in the art without departing from the scope and spirit of the invention set forth in the claims.

What is claimed is:

1. A plug connector with safety switch, comprising a terminal strip, resistor, LED, vector board, switch base, cover, socket and so on. There are an upper connecting member and a lower connecting member being merged to define an accommodating groove on one side, and said connected base having two terminal strips of the same electric polarity and an electric wire, and an terminal strip at the end S of different polarity coupled with a bi-directional groove track on the angular terminal strip; two electrical connecting ends having an electric wire connected to a resistor of a LED disposed under said accommodating chamber, and the platform of said empty chamber having a protruded terminal strip and a protruded sphere at the contact terminal strip, and two shoulder members of the protruded terminal strip providing the support and engagement for said vector strips; a switch connecting member hole accommodating a bouncing element with a contractible valve axle to enter into said accommodating chamber such that the front half of the arc surface of said valve axle attaches to the curved track of said vector board; a cover mounted onto an external frame to prevent water from permeating inside and causing a short circuit; such arrangement of the safety switch connector preventing sparks, static charges, and other dangers to users.

2. The plug connector with safety switch of claim 1, wherein said platform having a protruded terminal strip on its surface for supporting and making the vector board to swing, and the radial corner of the valve axle normally attaching onto the curved track of the board for the clockwise and anticlockwise swinging switch.

3. The plug connector with safety switch of claim 1, wherein said bouncing member in said connecting member hole reciprocating on the curved track surface, such that said valve axle performing a vertical piston movement to cope with the swinging control function.
